(19) United States
(12) Patent Application Publication
(10) Pub. No.: US 2026/0227185 A1
(43) Pub. Date: Aug. 6, 2026

(54) OPTICAL DATA PROCESSING DEVICE, OPTICAL DATA PROCESSING METHOD, AND OPTICAL DATA PROCESSING PROGRAM

(71) Applicant: TOPCON CORPORATION, Tokyo (JP)

(72) Inventor: You SASAKI, Tokyo (JP)

(73) Assignee: TOPCON CORPORATION, Tokyo (JP)

(21) Appl. No.: 19/152,054

(22) PCT Filed: Jan. 24, 2024
(86) PCT No.: PCT/JP2024/002114

§ 371 Date: Oct. 3, 2025

(30) Foreign Application Priority Data
Feb. 3, 2023 (JP) 2023-015339

(51) Int. Cl. G01C 11/02; G01C 15/00; G06T 7/70

(52) U.S. Cl. CPC G01C 11/02; G01C 15/00; G06T 7/70

(57) ABSTRACT

A technique for easily obtaining exterior orientation parameters of a camera externally attached to a surveying device is provided. An optical data processing unit includes: an image data receiving unit that receives image data of multiple first images obtained by a first camera equipped to a surveying device photographing images in multiple different directions, and data of wide-angle images photographed by a second camera that is externally attached to the surveying device and photographs an area wider than the photographing range of the first camera a feature extracting unit that extracts features from the multiple first images and the wide-angle images; an image detecting unit that detects specific images in the multiple first images whose features satisfy specific conditions, and partial images in the wide-angle images whose features satisfy the specific conditions; a correspondence relationship specifying unit that specifies the correspondence relationship between the specific images and the partial images; and an orientating unit that calculates relationships of location and orientation between the first camera and the second camera based on the correspondence relationship.

### TECHNICAL FIELD

The present invention relates to calibration of a camera which is externally attached to surveying devices.

### BACKGROUND ART

A surveying device is known such as a total station, a laser scanner or the like (for example, see Patent Document 1).

The Patent Document is as follows.

### Patent Document 1: Japanese Unexamined Patent Application Publication No. 2021-056069

### SUMMARY OF INVENTION

It is useful if a camera is externally attached to a surveying device such as total station or laser scanner so that image of appearance of a survey object is obtained using this camera. A surveying device including camera is known; however, in a case in which wide-angle image or all-around image is required to be photographed, it is useful if the camera can be externally fixed to the surveying device.

In the case in which a camera is externally attached to a surveying device, there may be a problem to obtain location and orientation of the camera with respect to the surveying device. A method in which calibration process is performed using a special target is considered; however, it is complicated and convenience is reduced. In view of such circumstances, an object of the present invention is to provide a technique in which location and orientation of a camera which is externally attached to a surveying device is easily obtained.

One aspect of the present invention is an optical data processing device including: an image detecting unit which detects a first image among images photographed by a first camera included in a surveying device and detects a second image among images photographed by a second camera externally attached to the surveying device; a correspondence relationship specifying unit which specifies a correspondence relationship between the first image and the second image; and an orientating unit which calculates relationships of location and orientation between the first camera and the second camera based on the correspondence relationship; in which the first image and/or the second image is detected as an image having feature points of the maximal number and/or an image having feature points of number larger than a predetermined value, from objective images.

In the present invention, an aspect can be mentioned in which the second camera is an all-around camera, the first image consists of multiple images which are obtained by the first camera photographing with respect to different multiple directions corresponding to range of photographing by the all-around camera, specifying of the correspondence relationship is performed with respect to a partial image in the second image, and the partial image is a partial image corresponding to angle of view of single image constituting the multiple first images.

In the present invention, an aspect can be mentioned in which the first image includes first multiple images in which directions of optical axes thereof are mutually different in a specific relationship, the partial image includes second multiple images in which directions of optical axes thereof are mutually different in the specific relationship, and the correspondence relationship specifying unit specifies correspondence relationship between the first multiple images and the second multiple images simultaneously. In the present invention, an aspect can be mentioned in which the surveying device includes a function to perform laser positioning, relationships of location and orientation between optical system performing the laser positioning and the first camera are known, location of feature of the first image is specified by the laser positioning, and based on the location of the feature of the first image, relationships of location and orientation between the first camera and the second camera are calculated.

Another aspect of the present invention is an optical data processing device including: an image data receiving unit which receives image data of images photographed by a camera externally attached to a surveying device having laser scanning function; a laser scan data receiving unit which receives laser scan data which is obtained by laser scanning using the laser scanning function; a feature obtaining unit from image, which obtains feature of photographing object based on the image data; a feature extracting unit from laser scan data, which extracts feature of the laser scanning object base on the laser scan data; a correspondence relationship specifying unit which specifies correspondence relationship between feature of the photographing object and feature of the scanning object; and an orientating unit which calculates relationships of location and orientation between the camera and the laser scanner based on the correspondence relationship; in which the feature of laser scanning object is a feature of image of which 3D model obtained by the laser scan data is viewed from location of the laser scanning.

Another aspect of the present invention is a method for processing optical data including steps of: detecting a first image among images photographed by a first camera included in a surveying device; detecting a second image among images photographed by a second camera externally attached on the surveying device; specifying correspondence relationship between the first image and the second image; and calculating relationships of location and orientation between the first camera and the second camera based on the correspondence relationship, wherein the first image and/or the second image is detected as an image having feature points of the maximal number and/or an image having feature points of number larger than a predetermined value, from objective images.

Another aspect of the present invention is a program made to, when read and executed by a computer processor, cause the computer processor to execute the following steps of: detecting a first image among images photographed by a first camera included in a surveying device; detecting a second image among images photographed by a second camera externally attached on the surveying device; specifying correspondence relationship between the first image and the second image; and calculating relationships of location and orientation between the first camera and the second camera based on the correspondence relationship; in which the first image and/or the second image is detected as an image having feature points of the maximal number and/or an image having feature points of number larger than a predetermined value, from objective images.

### Effects of Invention

According to the present invention, a technique can be obtained in which location and orientation of a camera externally attached to a surveying device are easily obtained.

### BRIEF DESCRIPTION OF DRAWINGS

FIG. 1 is a conceptual view showing overview of the embodiment.

FIG. 2 is perspective views (A) and (B) showing examples of the surveying device.

FIG. 3 is a block diagram of the surveying device.

FIG. 4 is a flowchart diagram showing one example of processing.

### EMBODIMENTS OF INVENTION

### 1. First Embodiment

### Summary

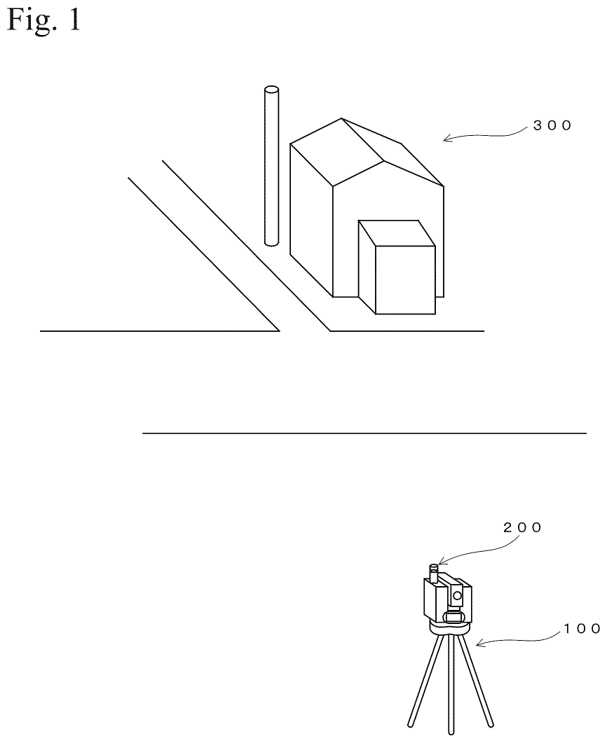

FIG. 1 shows a total station 100 which is one example of a surveying device and a survey object 300 which is surveyed by the total station 100. An all-around camera 200 is externally attached to the total station 100. The all-around camera 200 is one example of wide-angle camera and is able to photograph in the range of 360 degrees therearound in the horizontal direction.

The survey object 300 is not limited in particular, and FIG. 1 shows a building and roads as an example. The total station 100 surveys the survey object 300 using the laser surveying function thereof, and the all-around camera 200 photographs circumference thereof.

### Surveying Device

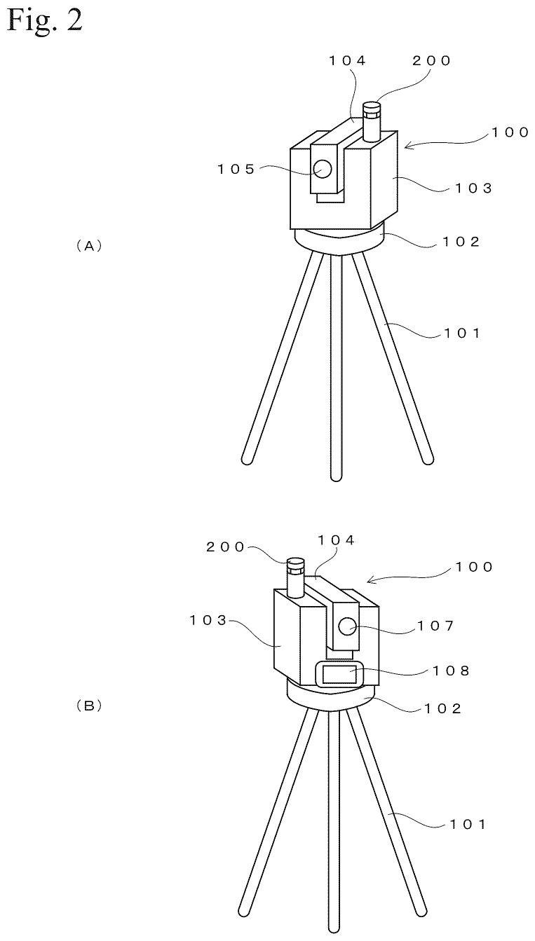

FIG. 2 shows a perspective view (A) of front side and a perspective view (B) of back side showing appearance of the total station 100. The total station 100 includes a tripod 101 which is supporting legs, a base unit 102 which is supported by the tripod 101, a horizontal rotating unit 103 which can rotate horizontally on the base unit 102, and a vertical rotating unit 104 which is held on the horizontal rotating unit 103 in a condition vertically rotatable.

Horizontal rotation is rotation around a vertical axis. Vertical rotation is rotation around an axis that extends horizontally.

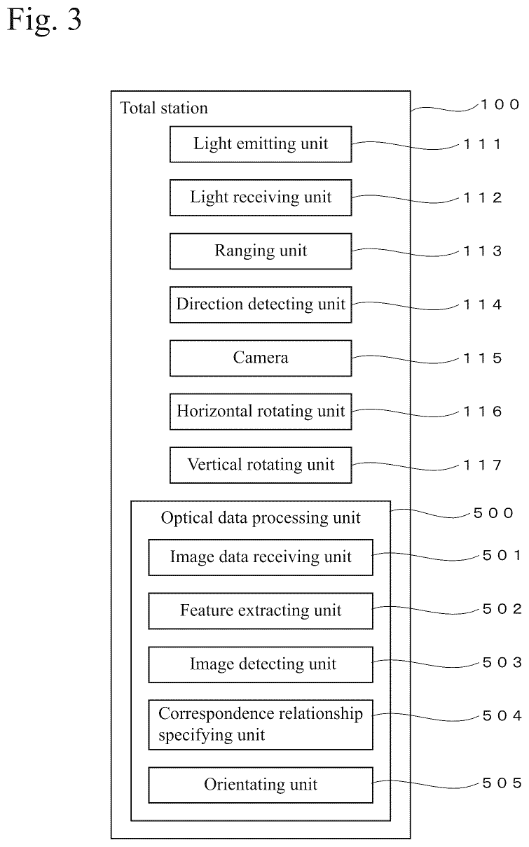

The vertical rotating unit 104 includes a telescope objective lens 105. The objective lens 105 also serves as an optical system for laser ranging light. A survey object is irradiated with ranging light and reflected ranging light from the survey object is received via the objective lens 105. An ocular unit 107 is provided on back side of the vertical rotating unit 104, and an image captured by the objective lens 105 can be viewed by looking through the ocular unit 107. A camera 115 (see FIG. 3) is also built into the vertical rotating unit 104, allowing the image captured by the objective lens 105 to be photographed. It is also possible to provide the optical system for the camera 115 separately from the objective lens 105.

Behind the objective lens 105, an optical system is arranged that branches an optical path to each of the ocular unit 107, the camera 115, a light emitting unit 111 (see FIG. 3), and a light receiving unit 112.

An all-around camera 200 is externally attached to upper part of the horizontal rotating unit 103. An attachment adaptor which is not shown in the figure is arranged on upper part of the horizontal rotating unit 103, and the all-around camera 200 is fixed thereon. An attachment location of the all-around camera 200 on the horizontal rotating unit 103 is determined, and when the all-around camera 200 is fixed to the horizontal rotating unit 103, a separation distance of the optical origin (projection center) of the all-around camera 200 from the optical origin (projection center) of the camera 115 and the optical origin (optical position that serves as the origin of optical surveying) of the total station 100 is set to be known values. In addition, it is assumed that internal orientation parameters of the camera 115 (see FIG. 3) and the all-around camera 200 are known.

Error may be generated or is actually contained in orientation (direction) of the all-around camera 200 with respect to the horizontal rotating unit 103. Therefore, when the error is left as it is, images photographed by the all-around camera 200 and survey results obtained by the total station 100 cannot be accurately correlated. That is, it is not possible to properly specify which specific part surveyed by the total station 100 corresponds to which part of image photographed by the all-around camera 200. The above-described correspondence becomes possible if the orientation of the all-around camera 200 relative to the horizontal rotating unit 103 (surveying device 100) is accurately determined. The orientation of the all-around camera 200 relative to the horizontal rotating unit 103 (surveying device 100) is acquired by a mechanism described below.

An operation panel 108 is arranged on the back of the horizontal rotating unit 103. The operation panel 108 is a touch panel display that is operated by an operator. By operating the operation panel 108, various settings and operations are performed.

### Block Diagram

FIG. 3 is a block diagram of the total station 100. In this example, the surveying device is a total station, but other surveying devices can also be used. The surveying device 100 includes the light emitting unit 111, the light receiving unit 112, a ranging unit 113, a direction detecting unit 114, the camera 115, a horizontal rotation driving unit 116, a vertical rotation driving unit 117, and an optical data processing unit 500.

The light emitting unit 111 includes a light emitting element which emits laser ranging light, a peripheral circuit of the light emitting element, and an optical system that guides the emitted laser ranging light to the objective lens 105. The light receiving unit 112 includes a light receiving element which detects laser ranging light reflected from survey object, a peripheral circuit of the light receiving element, and an optical system that guides the reflected light incident in the objective lens 105 to the light receiving element.

The ranging unit 113 measures distance from the optical origin point of the total station 100 to an object which reflects laser ranging light by the conventional principle of electro-optical distance measuring instrument. The direction detecting unit 113 detects horizontal rotation angle of the horizontal rotating unit 103 and vertical rotation angle of the vertical rotation unit 105 (elevation angle or depression angle). The horizontal rotation angle of the horizontal rotating unit 103 and the vertical rotation angle of the vertical rotation unit 105 are measured by an encoder and the measured values thereof are read.

The camera 115 photographs an image which is captured by the objective lens 105. The photographed image is a still image and a video image. The camera 115 has a limited range of photography. In particular, when the optical magnification of a telescope is increased, the field of view narrows, and photographing range of the camera 115 also narrows. Relationships of location and orientation of the camera 115 with respect to the optical system of the total station 100 are known. In addition, internal orientation parameters of the camera 115 are also known.

The horizontal rotation driving unit 116 includes a driving circuit and gear mechanism for horizontal rotation of the horizontal rotating unit 103. The vertical rotation driving unit 117 includes a driving circuit and gear mechanism for vertical rotation of the vertical rotating unit 104.

The surveying device 100 includes the optical data processing unit 500. The optical data processing unit 500 performs processing to calculate location and orientation of the all-around camera 200 with respect to the horizontal rotating unit 103 (surveying device 100).

The optical data processing unit 500 is a computer including CPU, storing unit and interface. The optical data processing unit 500 includes an image data receiving unit 501, a feature extracting unit 502, an image detecting unit 503, a correspondence relationship specifying unit 504, and orientating unit 505. It is also possible to provide the optical data processing unit 500 as an independent device. For example, the optical data processing unit 500 can be realized by using an independent PC (personal computer) or data processing server.

The image data receiving unit 501 obtains image data of the images photographed by the camera 115 installed in the surveying device 100 and image data of all-around image photographed by the all-around camera 200. The camera 115 photographs toward different multiple directions and obtains multiple photographed images. Image data of these multiple photographed images are received in the image data receiving unit 501.

The feature extracting unit 502 extracts features that characterize shape of an object from the image. The features in the image are undulating parts, convex parts, concave parts, edges, corners, and parts with small curvature that characterize the shape of the photographed object.

The image detecting unit 503 detects an image which satisfies specific conditions among multiple images obtained by the camera 115 photographing different multiple directions. In addition, the image detecting unit 503 detects a partial image which is a partial image satisfying the specific conditions among the all-around image photographed by the all-around camera 200. This partial image is an image which is a part of a specific limited range in the all-around image.

As the specific condition, image and partial image in which feature is greatest among images for object of detecting can be mentioned. Angle of view of the partial image detected from the all-around image is set to match angle of view of the image photographed by the camera 115. In this way, accuracy of specifying the correspondence relationship described below can be improved. For example, it is assumed that an image with the greatest feature is detected from certain multiple images photographed by the camera 115. In this case, from the all-around image photographed by the all-around camera 200, a range with the greatest feature and within the same range of angle of view as the above selected image is detected as the partial image.

A case can be mentioned in which an image and a partial image which have feature points more than the number preliminarily determined are selected as the specific conditions. Here, if there are multiple candidates that meet the conditions, a condition with the smallest deviation in the distribution of feature points is selected. In addition, an embodiment is also possible in which images in which the deviation in the distribution of feature points is not more than a predetermined threshold are selected, and then images in which the number of feature points is above a specified value are selected. The more evenly and widely the feature points are distributed within the image to some extent, the higher the accuracy of the orientation. Therefore, it is preferable that the images used for orientation of the camera 115 and the all-around camera 200 have a small deviation in the distribution of feature points.

The correspondence relationship specifying unit 504 specifies correspondence relationship between a specific image which is detected by the image detecting unit 503 among the multiple image photographed by the camera 115 and a partial image which is detected by the image detecting unit 503 among the all-around photographed image photographed by the all-around camera 200. The orientating unit 505 performs orientating the camera 115 and the all-around camera 200 based on the above correspondence relationship. Hereinafter principle of orientating performed in the present invention is explained. Now, it is assumed that the correspondence relationship between the specific image photographed by the camera 115 and the partial image that is a part of the all-around image photographed by the all-around camera 200 has been specified.

Relative relationships of location and orientation of the camera 115 and the all-around camera 200 are obtained by the principle of mutual orientation using the image which the correspondence relationship has been specified. Here, information of separation distance between the camera 115 and the all-around camera 200 is known. Therefore, a scale is imparted to the relative relationships of location and orientation between the camera 115 and the all-around camera 200 thereby enabling absolute orientation. Accordingly, relationships of location and orientation between the camera 115 and the all-around camera 200 are obtained. This processing is performed in the orientating unit 505.

It should be noted that since the location and orientation of the camera 115 with respect to the total station 100 are known, by obtaining the relationships of location and orientation between the camera 115 and the all-around camera 200, relationships of location and orientation of the all-around camera 200 with respect to the total station 100 can also be obtained. That is, as a result of the above orientation, the relationships of location and orientation of the all-around camera 200 with respect to the total station 100 can be obtained.

It should be noted that if an image which gives scale is shown in two images in which the correspondence relationship is specified, absolute orientation is possible and the relationships of location and orientation between the camera 115 and the all-around camera 200 can be obtained. As a method to impart the scale, one method is to commonly photograph two or more reference points (for example, reference point targets) with a known separation distance or a member with a known length (for example, a pole or ruler with a known length). Furthermore, absolute orientation can also be performed by using a total station 100 equipped with a function to emit marker light, projecting a scale using this marker light (for example, projecting a longitudinal image with a length of 1 m), and detecting it in the image.

### One Example of Processing

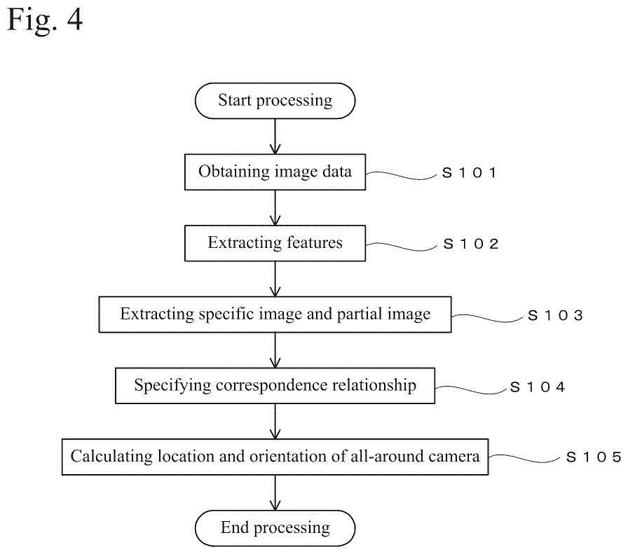

FIG. 4 is a flowchart diagram showing one example of processing which is performed by the optical data processing unit 500. A program which executes the processing of FIG. 4 is stored in a storing unit of a computer constructing the optical data processing unit 500 or an appropriate storing medium, and is executed by CPU of the computer.

First, image data of multiple first images photographed by the camera 115 and image data of all-around image photographed by the all-around camera 200 are obtained (Step S101). Here, the multiple first images are obtained by taking a panoramic photograph by the camera 115 while horizontally rotating the horizontal rotating unit 103. The multiple first images are photographed so that adjacent photographed images partially overlap, and the overlapping portions are overlapped and joined together in the horizontal direction to obtain a panoramic all-around image.

Once the image data is obtained, features are extracted from the multiple first images and the all-around image photographed by the all-around camera 200 (Step S102). Next, from the multiple first images, an image with the largest feature amount is extracted as a specific image, and from the all-around image photographed by the all-around camera 200, an image region with the largest feature amount is extracted as a partial image (Step S103). Here, the range of the field of view (angle of view) of the first image is known, and the range of the partial image is determined so as to have an image range that is approximately the same as that range.

Next, correspondence relationship of the first images and partial image extracted in Step S103 is specified (Step S104). Here, feature part in the first images and feature part in the partial image are compared, and the correspondence relationship of them is specified. It should be noted that if the specification of the correspondence relationship is difficult, the partial image is obtained again and Step S104 is executed again.

Next, based on the correspondence relationship obtained in Step S104, orientation is performed so as to calculate relationships of location and orientation between the camera 115 and the all-around camera 200 (Step S105).

In this way, the relationships of location and orientation of the all-around camera 200 with respect to the camera 115 (and the total station 100) are determined, and the correspondence relationship between survey data measured by the total station 100 or photographed content of the camera 115 and the all-around image photographed by the all-around camera 200. For example, data can be obtained in which the survey data by the total station is embedded in the all-around image photographed by the all-around camera 200.

### 2. Second Embodiment

It is also possible to collectively compare multiple images with many features among the images photographed by the camera 115 with the all-around image photographed by the all-around camera 200, and specify the correspondence relationship between the two.

For example, among multiple images which are photographed toward multiple directions by the camera 115, two images with many feature points are obtained from two directions. It is assumed that these two directions have, for example, optical axis directions mutually different at 30 degrees within horizontal plane.

Correspondence relationship between these two images and the all-around image photographed by the all-around camera 200 is calculated. At this time, partial images are extracted from two directions which are different at 30 degrees in horizontal plane and have many features from the all-around image, and these two partial images and the above-mentioned two images are compared simultaneously, so as to obtain the correspondence relationship.

Once the above correspondence relationship is determined, relationship between the two directions as seen from the camera 115 and the two directions as seen from the all-around camera 200 can be determined, and the relationships of location and orientation between the camera 115 and the all-around camera 200 can be determined. It should be noted that if the correspondence relationship cannot be calculated, images from other two directions that are 30° different in horizontal plane in the all-around image are extracted again, and the same processing is performed again.

According to this method, since features of multiple directions are used simultaneously, accuracy of matching (accuracy calculating the correspondence relationship) can be increased. This method is effective in a case in which there are many features in multiple directions. The number of the multiple images of different directions having many features photographed by the camera 115 is not limited to 2, and the number can be 3 or more unlike in the above case.

As a method for obtaining images having many features from multiple images photographed by the camera 115, for example, a method in which multiple images are selected from the top of many features (for example, first and second), and a method in which threshold is set and images having feature amount not less than this threshold are selected, can be mentioned.

In the method in which two or more images having features are selected from the multiple images photographed by the camera 115, two or more images each selected under different conditions related to feature points may be included. For example, as different conditions, a condition focusing on the number of feature points and a condition focusing on the distribution of feature points may be adopted.

In this Embodiment, the roles of the camera 115 and the all-around camera 200 may be substituted. In this case, multiple partial images characterized by the presence of feature points in multiple directions are obtained from the all-around image photographed by the all-around camera 200, and multiple images corresponding to these multiple directions are extracted from the large number of images photographed by the camera 115. The multiple partial images are then compared with the multiple images extracted from the images photographed by the camera 115. Here, if the approximate relationship of orientation between the camera 115 and the all-around camera 200 is known, the camera 115 can photograph multiple images with a certain degree of precision, thereby reducing the number of times that images are photographed.

### 3. Third Embodiment

Positioning of multiple feature parts obtained from the images photographed by the camera 115 can be performed using laser surveying function of the total station 100, and the position data can be used to determine the location and orientation of the all-around camera 200 in the total station 100 by single-photo orientation.

In this case, the correspondence relationship between the image photographed by the camera 115 (first image) and the partial image (second image) obtained from the all-around image is determined. Furthermore, the multiple feature parts in the first image are positioned using the laser surveying function of the total station 100. Since the correspondence relationship of features between the first image and the second image has been determined, the locations of multiple feature parts in the second image can be specified based on the locations of the multiple feature parts in the first image. Therefore, the location and orientation of the all-around camera 200 relative to the total station 100 and the camera 115 can be determined by single-photo orientation using the locations of the multiple feature parts in the second image.

### 4. Fourth Embodiment

The total station 100 may have a laser scanning function. One embodiment of this laser scanning function includes using the laser surveying function of the total station 100 to position grid-like points so as to obtain point cloud data, and another embodiment includes equipping the total station 100 with a laser scanner separate from the laser surveying function. Here, information on location and orientation of the laser scanner relative to the total station 100 is assumed to be known.

In this case, it becomes possible to specify the locations of multiple feature parts obtained from the image photographed by the camera 115, and therefore it becomes possible to perform processing similar to that in the third embodiment.

### 5. Fifth Embodiment

A laser scanner can also be used as the surveying device. In this case, the laser scanner is employed instead of the total station 100, and the all-around camera 200 is externally attached to this laser scanner. The laser scanner also includes the optical data processing unit 500 shown in FIG. 3. In this case, the optical data processing unit 500 further includes a laser scan data receiving unit and a feature obtaining unit from laser scan data that acquires features of the scanned object based on the laser scan data.

In this case, the features are extracted from the multiple images photographed by the camera 115, and an image with many features is further detected as a specific image. On the other hand, a 3D model of the laser scan object is generated based on the laser scan data, and a 3D model image is generated, which is an image of this 3D model as viewed from the location of the laser scanner. This 3D model image is an image of the 3D model of the laser scan object. If the laser scanning is an all-around scanning, this 3D model image becomes an all-around 3D model image. Then, an image of a part with many features is extracted as a partial image from this all-around 3D model image. This processing is performed in the feature obtaining unit from laser scan data. The range of the angle of view of the partial image is the same as in the first embodiment.

Then, the specific image and the partial image are compared to obtain the correspondence relationship of them. In this way, the location and orientation of the all-around camera 200 relative to the laser scanner can be calculated based on the principle of single-photo orientation. Of course, the location and orientation of the all-around camera 200 relative to the laser scanner can also be calculated using mutual orientation and absolute orientation based on the specific image and the partial image whose correspondence relationship has been specified.

### 6. Another Variation 1

As the external camera, a wide-angle camera that photographs a wider angle range than that of the camera 115 can be used instead of the all-around camera 200. In this case, location and orientation of the external wide-angle camera in the surveying device can be obtained.

The external camera is not limited to the all-around camera or the wide-angle camera. For example, a camera having a function not available in the camera 115, a camera with a higher resolution than the camera 115, a camera photographing images at a wavelength different from that of the camera 115, a multispectral camera, a hyperspectral camera, an infrared camera, or the like can be used as the external camera. In addition, a smartphone with a camera can also be used as the external camera. Furthermore, an embodiment is also available in which video is recorded using the external camera.

### 7. Another Variation 2

The following orientation method is also possible. Hereinafter, a camera built into the surveying device (corresponding to the camera 115) will be referred to as a built-in camera, and a camera attached externally to the surveying device will be referred to as an external camera. Furthermore, the external camera is not a wide-angle camera, but rather a camera that photographs a relatively narrow range. It should be noted that the angle of view of the external camera and the built-in camera do not have to be the same.

First, it is assumed that relationship of orientation between the built-in camera and the external camera is known to some extent (approximately). Here, it is assumed that the external camera is attached to the surveying device so that it is approximately aligned with the optical axis of the built-in camera. In this case, the external camera photographs an all-around image. This all-around photographing is performed by photographing multiple images while slightly shifting the direction. Instead of photographing all-around image, it is also possible to visually aim in multiple directions where there are likely to be many feature points and photograph images therefor.

Then, from the multiple images photographed by the external camera, the image with the largest number of feature points is selected. The surveying device is pointed in this direction of the image with the largest number of feature points, and the built-in camera is used to photograph the image. At this time, since the direction is approximately correct, though not exactly, the image photographed by the built-in camera captures the area with the largest number of feature points. Orientation is then performed to obtain the precise relationships of location and orientation between the built-in and external cameras.

When photographing images using the external camera, the photographing may be stopped once an image with a number of feature points exceeding a predetermined number is obtained, and orientation may be performed using that image. In this example, the use of the built-in and external cameras may also be substituted.

### 8. Another Variation 3

It is assumed that the optical axes of the built-in and external cameras are aligned in approximately the same direction. In this case, an all-around image is photographed using both the external and built-in cameras. This all-around image is photographed by photographing multiple images while slightly shifting the direction. Instead of photographing the all-around image, it is also possible to visually aim in multiple directions likely to contain many feature points and photograph the images. Furthermore, during photographing, the built-in and external cameras are synchronized, and images photographed by the built-in and external cameras when the surveying device is pointed in a specific direction are associated with each other.

Then, from the multiple images photographed by the built-in camera, the image with the largest number of feature points is selected. Since the orientation is approximately correct, though not exactly, the image photographed with the external camera which is pointed in the same direction will photograph the area with the largest number of feature points. Orientation is then performed to obtain the precise relationships of location and orientation between the built-in and external cameras. The use of the external and built-in cameras may be substituted as in the above case.

### 9. Another Variation 4

From the images photographed in multiple directions by the external camera, multiple images with a number of feature points greater than a specified value (first image group) may be selected. The direction of these multiple images may then be photographed with the built-in camera to obtain multiple similar images (second image group), and the correspondence relationship between the first and second image groups may be determined.

The first and second image groups may include two or more images selected based on different conditions related to feature points. For example, the different conditions may include a condition focusing on the number of feature points and a condition focusing on the distribution of feature points. In this example, the roles of the built-in camera and the external camera may be substituted.

### EXPLANATION OF REFERENCE NUMERALS

100: Total station device (surveying device), 101: tripod, 102: base unit, 103: horizontal rotating unit, 104: vertical rotating unit, 105: objective lens (optical system), 107: ocular unit, 108: operation panel, 200: all-around camera, and 300: survey object

1. An optical data processing device comprising:
an image detecting unit which detects a first image among images photographed by a first camera included in a surveying device and detects a second image among images photographed by a second camera externally attached to the surveying device,
a correspondence relationship specifying unit which specifies a correspondence relationship between the first image and the second image, and
an orientating unit which calculates relationships of location and orientation between the first camera and the second camera based on the correspondence relationship,
wherein the first image and/or the second image is detected as an image having feature points of the maximal number and/or an image having feature points of number larger than a predetermined value, from objective images.

2. The optical data processing device according to claim 1,
wherein the second camera is an all-around camera,
the first image consists of multiple images which are obtained by the first camera photographing with respect to different multiple directions corresponding to range of photographing by the all-around camera,
specifying of the correspondence relationship is performed with respect to a partial image in the second image, and
the partial image is a partial image corresponding to angle of view of single image constituting the multiple first images.

3. The optical data processing device according to claim 2,
wherein the first image includes first multiple images in which directions of optical axes thereof are mutually different in a specific relationship,
the partial image includes second multiple images in which directions of optical axes thereof are mutually different in the specific relationship, and
the correspondence relationship specifying unit specifies correspondence relationship between the first multiple images and the second multiple images simultaneously.

4. The optical data processing device according to claim 1,
wherein the surveying device includes a function to perform laser positioning,
relationships of location and orientation between optical system performing the laser positioning and the first camera are known,
location of feature of the first image is specified by the laser positioning, and
based on the location of the feature of the first image, relationships of location and orientation between the first camera and the second camera are calculated.

5. An optical data processing device comprising:
an image data receiving unit which receives image data of images photographed by a camera externally attached to a surveying device having laser scanning function,
a laser scan data receiving unit which receives laser scan data which is obtained by laser scanning using the laser scanning function,
a feature obtaining unit from image, which obtains feature of photographing object based on the image data,
a feature extracting unit from laser scan data, which extracts feature of the laser scanning object base on the laser scan data,
a correspondence relationship specifying unit which specifies correspondence relationship between feature of the photographing object and feature of the scanning object, and
an orientating unit which calculates relationships of location and orientation between the camera and the surveying device based on the correspondence relationship,
wherein the feature of laser scanning object is a feature of image of which 3D model obtained by the laser scan data is viewed from location of the laser scanning.

6. A method for processing optical data comprising steps of:
detecting a first image among images photographed by a first camera included in a surveying device,
detecting a second image among images photographed by a second camera externally attached on the surveying device,
specifying correspondence relationship between the first image and the second image, and
calculating relationships of location and orientation between the first camera and the second camera based on the correspondence relationship,
wherein the first image and/or the second image is detected as an image having feature points of the maximal number and/or an image having feature points of number larger than a predetermined value, from objective images.

7. A non-transitory computer recording medium storing computer executable instructions, the computer executable instructions made to, when read and executed by a computer processor, cause the computer processor to execute the following steps of:
detecting a first image among images photographed by a first camera included in a surveying device,
detecting a second image among images photographed by a second camera externally attached on the surveying device,
specifying correspondence relationship between the first image and the second image, and
calculating relationships of location and orientation between the first camera and the second camera based on the correspondence relationship,
wherein the first image and/or the second image is/are detected as an image having feature points of the maximal number and/or an image having feature points of number larger than a predetermined value, from objective images.

8. The optical data processing device according to claim 2,
wherein the surveying device includes a function to perform laser positioning,
relationships of location and orientation between optical system performing the laser positioning and the first camera are known,
location of feature of the first image is specified by the laser positioning, and
based on the location of the feature of the first image, relationships of location and orientation between the first camera and the second camera are calculated.

9. The optical data processing device according to claim 3,
wherein the surveying device includes a function to perform laser positioning,
relationships of location and orientation between optical system performing the laser positioning and the first camera are known,
location of feature of the first image is specified by the laser positioning, and
based on the location of the feature of the first image, relationships of location and orientation between the first camera and the second camera are calculated.
